(19) United States
(12) Patent Application Publication
(10) Pub. No.: US 2025/0158039 A1
(43) Pub. Date: May 15, 2025

(54) NICKEL-RICH CATHODE MATERIALS WITH INLAID THERMALLY-STABLE NANO-PARTICLES

(71) Applicant: GM GLOBAL TECHNOLOGY OPERATIONS LLC, Detroit, MI (US)

(72) Inventors: Dewen KONG, Shanghai (CN); Meiyuan WU, Shanghai (CN); Yan WU, Shanghai (CN); Jingyuan LIU, Shanghai (CN); Haijing LIU, Shanghai (CN)

(21) Appl. No.: 18/915,027

(22) Filed: Oct. 14, 2024

(30) Foreign Application Priority Data
Nov. 14, 2023 (CN) 2023115176176

(51) Int. Cl. H01M 4/36; H01M 4/02; H01M 4/131; H01M 4/1391; H01M 4/525; H01M 4/62; H01M 10/42

(52) U.S. Cl. CPC H01M 4/366; H01M 4/131; H01M 4/1391; H01M 4/525; H01M 4/62; H01M 10/4235; H01M 2004/028

(57) ABSTRACT

A cathode electrode includes a cathode current collector and a cathode active material layer comprising a plurality of cathode active material particles including nickel and a plurality of nano-particles that are mechanically inlaid on outer surfaces of the plurality of cathode active material particles to form a plurality of inlaid cathode active material particles.

### CROSS-REFERENCE TO RELATED APPLICATIONS

This application claims the benefit of Chinese Patent Application No. 202311517617.6 filed on 8638. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to cathode materials for battery cells, and more particularly to nickel-rich cathode materials with inlaid thermally-stable non-particles.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

Battery cells include cathode electrodes, anode electrodes, separators, and electrolyte arranged in an enclosure. The cathode electrodes include a cathode active material layer (including cathode active material) arranged on a cathode current collector. The anode electrodes include an anode active material layer (including anode active material) arranged on an anode current collector.

### SUMMARY

A cathode electrode includes a cathode current collector and a cathode active material layer comprising a plurality of cathode active material particles including nickel and a plurality of nano-particles that are mechanically inlaid on outer surfaces of the plurality of cathode active material particles to form a plurality of inlaid cathode active material particles.

In other features, the plurality of cathode active material particles comprise a rock salt layered oxide including nickel. The plurality of cathode active material particles are selected from a group consisting of LiNiₓMn_{y}Co_{1-x-y}O₂, LiNₓCo_{y}Al_{1-x-y}O₂, LiNiₓCo_{y}Mn_{z}Al_{1-x-y-z}O₂, LiNiₓMn_{y}Al_{1-x-y}O₂, LiNiₓMn₁₋ₓO₂, and LiNiO₂. The plurality of nano-particles comprise 1% to 25% of a mass ratio of inlaid cathode active material particles.

In other features, the plurality of nano-particles are selected from a group consisting of olivine type, spinel type, MnNiO₂ type, and combinations thereof. The plurality of nano-particles are selected from a group consisting of LiVOPO₄, LMFP, AlPO₄, CoPO₄, LiTi₂(PO₄)₃, LMO, LNMO, LiMn_{0.7}Ni_{0.3}O₂, and combinations thereof. The plurality of nano-particles comprise LMFP selected from a group consisting of LiMnₓFe₁₋ₓPO₄, LiMn_{0.7}Fe_{0.3}PO₄, LiMn_{0.6}Fe_{0.4}PO₄, LiMn_{0.8}Fe_{0.2}PO₄, LiMn_{0.75}Fe_{0.25}PO₄, and combinations thereof. The plurality of nano-particles comprise doped LMFP.

In other features, the plurality of nano-particles comprise LMFP and a particle size of the LMFP is in a range from 10 nm to 1000 nm. The plurality of nano-particles comprise LMFP and a tap density of the LMFP is in a range from 0.3 g/cc to 2.0 g/cc. The plurality of nano-particles comprise LMFP and a specific area of the LMFP is in a range from 3 m²/g to 50 m²/g.

In other features, a carbon coating layer is arranged on an outer surface of the plurality of inlaid cathode active material particles. The carbon coating layer comprises at least one of carbon and N-doped carbon. The carbon coating layer comprises 0.5 wt % to 10% mass ratio of the inlaid cathode active material particles.

A method for manufacturing a cathode electrode for a battery includes providing a plurality of cathode active material particles including nickel; and mechanically inlaying a plurality of nano-particles on an outer surface of the cathode active material particles to form inlaid cathode active material particles.

In other features, the method includes creating a mixture including the inlaid cathode active material particles, a conductive additive, and a binder; and coating a cathode current collector with the mixture.

In other features, the method includes forming a carbon coating layer on the inlaid cathode active material particles.

In other features, the cathode active material particles are selected from a group consisting of LiNiₓMn_{y}Co_{1-x-y}O₂, LiNₓCo_{y}Al_{1-x-y}O₂, LiNiₓCo_{y}Mn_{z}Al_{1-x-y-z}O₂, LiNiₓMn_{y}Al_{1-x-y}O₂, LiNiₓMn₁₋ₓO₂, and LiNiO₂. The plurality of nano-particles are selected from a group consisting of olivine type, spinel type, MnNiO₂ type, and combinations thereof. The plurality of nano-particles are selected from a group consisting of LiVOPO₄, LMFP, AlPO₄, CoPO₄, LiTi₂(PO₄)₃, LMO, LNMO, LiMn_{0.7}Ni_{0.3}O₂, and combinations thereof.

In other features, the plurality of nano-particles comprise doped LMFP.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross sectional view of an example of a battery cell including cathode electrodes with Ni-rich cathode active material including inlaid nano-particles, anode electrodes, and separators arranged in a battery cell enclosure according to the present disclosure;

FIG. 2 is a graph illustrating an example of heat flow as a function of temperature for a Ni-rich cathode active material such as NMCA;

FIG. 3 is a graph illustrating cell temperature and cell voltage as a function of time for an NMCA cathode electrode and a graphite anode;

FIG. 4 is a cross sectional view of a Ni-rich particle of cathode active material including inlaid thermally-stable nano-particles according to the present disclosure;

FIG. 5 is a cross sectional view of a Ni-rich particle of cathode active material including inlaid thermally-stable nano-particles and a carbon coating layer according to the present disclosure;

FIG. 6 is a side cross sectional view of a portion of a mechanical fusion machine for inlaying the thermally-stable nano-particles on outer surfaces of Ni-rich particles of cathode active material according to the present disclosure;

FIG. 7 is a flowchart of a method for inlaying thermally-stable nano-particles into a Ni-rich particle of cathode active material according to the present disclosure;

FIGS. 8A to 8C are scanning electron microscope (SEM) images showing outer surfaces of Ni-rich particles of cathode active material, nano-particles, and/or nano-particles inlaid into the Ni-rich particles of cathode active material according to the present disclosure; and

FIG. 9 is a graph illustrating an example of heat flow as a function of temperature for a Ni-rich cathode active material with inlaid nano-particles according to the present disclosure.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

As described above, battery cells include cathode electrodes, anode electrodes, separators, and electrolyte arranged in an enclosure. The cathode electrodes include a cathode active material layer (including cathode active material) arranged on a cathode current collector. In some examples, the cathode active material includes nickel-rich (Ni-rich) cathode material. Ni-rich cathode active materials such as NCMA, NCA and NMC811 are thermally unstable since they decompose below 300° C. and generate molecular oxygen (O₂). When the O₂ is released, it reacts with flammable cell contents and increases the likelihood of thermal events such as thermal runaway.

The present disclosure relates to Ni-rich cathode active material including thermally stable nano-particles (e.g., LMFP) mechanically inlaid on an outer surface of the Ni-rich cathode active material to enhance cell thermal performance. Interfaces between the nano-particles and the outer surface of the Ni-rich cathode active material exhibit robust fusion force to mechanically maintain the architecture. The nano-particles improve thermal stability and are not stripped during electrode fabrication or cycling. For example, cathode active material including the Ni-rich cathode material with 5 wt % of the nano-particles (e.g., LMFP) provides a 9% reduction in heat generation when in contact with electrolyte during differential scanning calorimetry (DSC) testing.

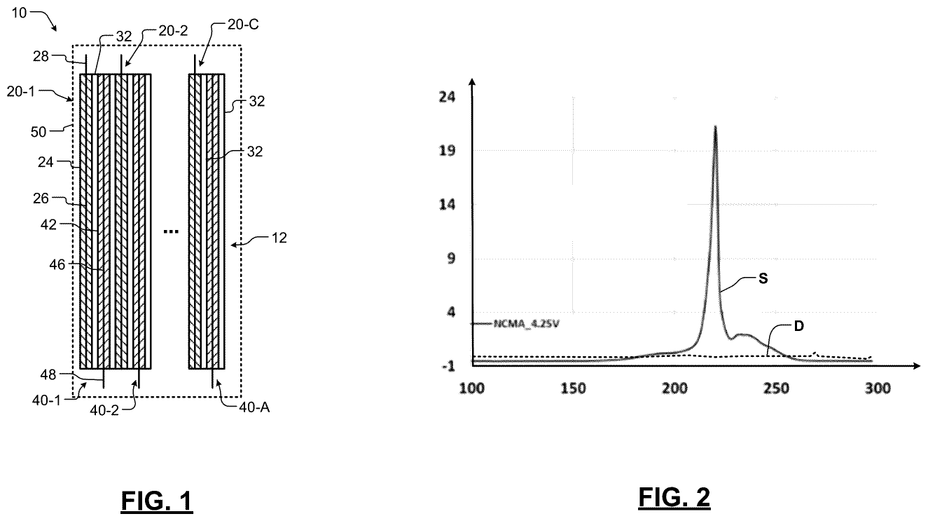

Referring now to FIG. 1, a battery cell 10 includes C cathode electrodes 20, A anode electrodes 40, and S separators 32 arranged in a predetermined sequence in a battery cell stack 12 located in an enclosure 50, where C, S and A are integers greater than zero. The C cathode electrodes 20-1, 20-2, . . . , and 20-C include cathode active material layers 24 arranged on one or both sides of cathode current collectors 26. The cathode active material layers 24 include Ni-rich cathode active material with inlaid thermally-stable nano-particles and/or Ni-rich cathode active material with inlaid thermally-stable nano-particles and a carbon coating layer as will be described further below.

The A anode electrodes 40-1, 40-2, . . . , and 40-A include anode active material layers 42 arranged on one or both sides of the anode current collectors 46. In some examples, the anode active material layers 42 and/or the cathode active material layers 24 are free-standing electrodes that are arranged adjacent to (or attached to) the cathode current collectors 26 and/or the anode current collectors 46, respectively. In some examples, the anode active material layers 42 and/or the cathode active material layers 24 comprise coatings including one or more active materials, one or more conductive fillers/additives, and/or one or more binder materials that are applied to the current collectors.

In some examples, the cathode current collectors 26 and/or the anode current collectors 46 comprise metal foil, metal mesh, and/or expanded metal. In some examples, the cathode current collectors 26 and/or the anode current collectors 46 are made of one or more materials selected from a group consisting of copper, stainless steel, brass, bronze, zinc, aluminum, and/or alloys thereof. External tabs 28 and 48 are connected to the current collectors of the cathode electrodes and anode electrodes, respectively, and can be arranged on the same or opposite sides of the battery cell stack 12. The external tabs 28 and 48 are connected to terminals of the battery cells.

Referring now to FIGS. 2 and 3, thermal performance of a Ni-rich cathode active material such as NMCA (without inlaid thermally-stable nano-particles) is shown. In FIG. 2, heat flow is shown as a function of temperature for the Ni-rich cathode active material during DSC testing (as shown by solid line S). In this example, an NCMA cathode was tested at 100% SOC with electrolyte. The temperature was increased at a rate of 5° C./minute to 300° C. Significant heat flow occurs at temperatures between 200° C. and 230° C. as O₂ is released. In contrast, the LMFP is thermally stable during testing up to 300° C. (as shown by dotted line D). In FIG. 3, cell temperature and cell voltage are shown as a function of time for an NMCA cathode electrode and a graphite anode.

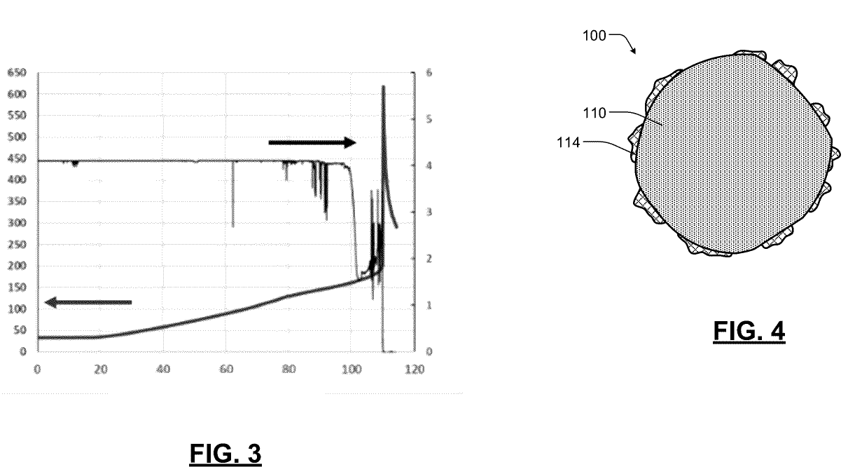

Referring now to FIGS. 4 and 5, examples of cathode active material with mechanically inlaid thermally-stable nano-particles is shown. In FIG. 4, inlaid cathode active material 100 includes a Ni-rich particle of cathode active material 110 and mechanically inlaid nano-particles 114 on an outer surface thereof. In FIG. 5, the inlaid cathode active material 110 includes the Ni-rich particle of cathode active material 110 including the mechanically inlaid nano-particles 114, and a carbon coating layer 118 arranged on an outer surface thereof.

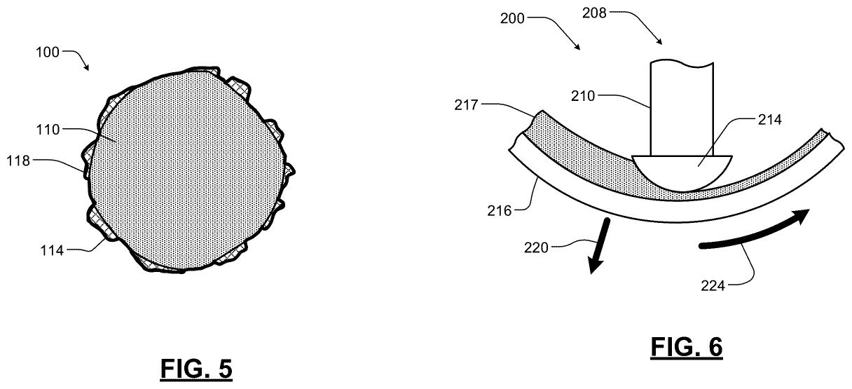

Referring now to FIG. 6, a mechanical fusion machine 200 may be used for mechanically inlaying the thermally-stable nano-particles on an outer surface of Ni-rich particles of cathode active material. The mechanical fusion machine 200 includes a rotor 216 that rotates (e.g., in a direction 224). The mechanical fusion machine 200 includes an inner surface and a press head 208 including a shaft 210 connected to a head 214. As the rotor 216 rotates, a mixture 217 of the Ni-rich cathode active material and the nano-particles is pressed against the inner surface of the rotor 216 by centrifugal force 220. The head 214 of the press head 208 presses the mixture 217 against the inner surface of the rotor 216 to mechanically fuse the nano-particles into the Ni-rich cathode active material. In some examples, the rotor 216 rotates at a speed of 2000 to 4000 rpm (e.g., 3000 rpm) for a predetermined period in a range from 3 to 10 minutes (e.g., 5 minutes).

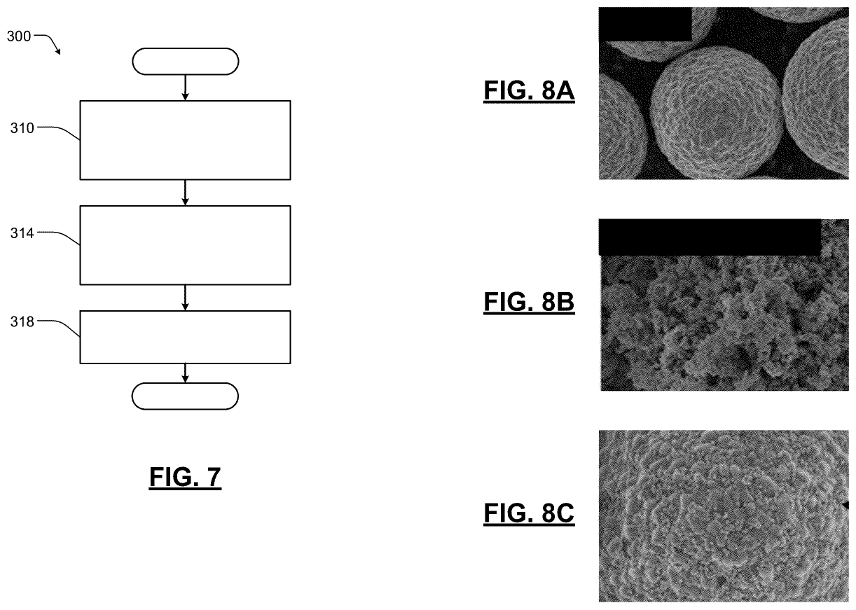

Referring now to FIG. 7, a method 300 for inlaying thermally-stable nano-particles into a Ni-rich particle of cathode active material is shown. At 310, the method includes arranging a mixture of Ni-rich cathode active material and thermally-stable nano-particles into a mechanical fusion machine. At 314, the thermally-stable nano-particles are pressed into the Ni-rich cathode active material (e.g., in a mechanical fusion machine).

At 318, the Ni-rich cathode active material with the inlaid nano-particles are optionally coated with a carbon coating layer. In some examples, the carbon coating layer comprises carbon or N-doped carbon. In some examples, the Ni-rich cathode active material with the inlaid thermally-stable nano-particles are annealed in the presence of a carbon source at a temperature in a range from 550° C. to 750° C. for a predetermined period in a range from 1 to 3 hours. In some examples, the carbon source is an organic carbon source. In some examples, the carbon source is selected from a group consisting of sucrose, glucose, and/or citric acid.

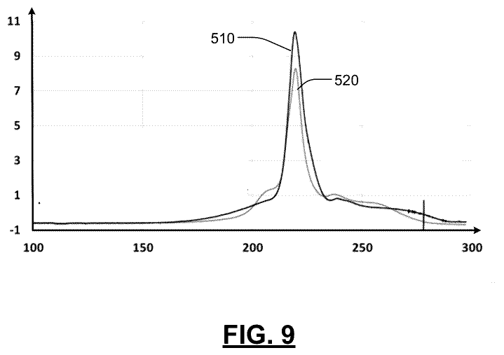

Referring now to FIGS. 8A to 8C, scanning electron microscope (SEM) views of an outer surface of Ni-rich particles of cathode active material, thermally-stable nano-particles, and thermally-stable nano-particles inlaid into the Ni-rich particles of cathode active material are shown. The thermally stable inlaid nano-particles were uniformly inlaid on the outer surface of the cathode active material.

Referring now to FIG. 9, heat flow is shown as a function of temperature for a Ni-rich cathode active material with inlaid thermally-stable nano-particles (at 520) as compared to the same cathode active material without inlaid nano-particles (at 510) during DSC testing. In this example, the inlaid particles comprise 5 wt % LMFP inlaid into NCMA comprising 95 wt % (e.g., NCMA active material, conductive additive, and PVDF binder with loading of ˜5 mAh/cm²). In this example, the cathode electrodes were tested at 100% SOC with electrolyte. The temperature was increased at a rate of 5° C./minute to 300° C. As can be appreciated, about 9% less heat flow occurs at temperatures between 200° C. and 230° C. for the NCMA cathode with inlaid nano-particles as compared to the NCMA cathode without inlaid nano-particles.

In some examples, the cathode active material includes Ni-rich rock salt layered oxides. Examples of Ni-rich rock salt layered oxides include LiNiₓMn_{y}Co_{1-x-y}O₂ (NMC) 811, LiNₓCo_{y}Al_{1-x-y}O₂ (NCA), LiNiₓCo_{y}Mn_{z}Al_{1x-y-z}O₂ (NCMA), LiNiₓMn_{y}Al_{1-x-y}O₂ (NMA), LiNiₓMn₁₋ₓO₂ (NM), and LiNiO₂ (LNO). In some examples, the Ni-rich cathode active material includes primary and secondary mono-sized particle type or bimodal type Ni-rich cathode material. In some examples, the primary particles have a D₅₀ size in a range from 1 μm to 20 μm (e.g., 3 μm to 6 μm) and the secondary particles have a D₅₀ size in a range from 3 μm to 15 μm.

In some examples, the cathode electrode is fabricated using a dry process. In some examples, the cathode active material layer includes the inlaid cathode active material that is combined with a conductive additive and a binder. In some examples, the mixture is sheared, pressed and/or heated and then coated on the cathode current collector.

In some examples, the ratio of the inlaid nano-particles on the Ni-rich cathode active material is in a range from 1 to 25% mass ratio. In some examples, the ratio of the inlaid nano-particles on the Ni-rich cathode active material is in a range from 2 to 15% mass ratio. In some examples, the ratio is calculated as set forth in Table 1 below:

| | | | | | Increased | |
|---|---|---|---|---|---|---|
| | LMFP inlaid layer | | diameter, | Volume, | valume by | LMFP inlaid |
| | thickness /um | D50 | um | um³ | LMFP, um³ | mass raito, % |
| Nickel-rich Cathode | 0 | 11.26 | 5.63 | 747.50 | 0 | / |
| Materials, e.g., NCMA | | | | | | |
| LMFP Inlaid Nickelrich | 2 | 15.26 (11.26 + 2 + 2) | 7.63 | 1860.64 | 1113.13 | 52.06 |
| Cathode Materials, | 1 | 13.26 (11.26 + 1 + 1) | 6.63 | 1220.76 | 473.25 | 31.58 |
| e.g., NCMA | 0.5 | 12.26 (11.26 + 0.5 + 0.5) | 6.13 | 964.87 | 217.37 | 17.49 |
| | 0.2 | 11.66 (11.26 + 0.2 + 0.2) | 5.83 | 830.03 | 82.53 | 7.45 |

Density of NCMA~4.8 g/cm3
Density of LMFP density~3.5 g/cm3

In some examples, the nano-particles are selected from a group consisting of olivine type, spinel type, MnNiO₂ type, or combinations thereof. Examples of olivine type include LiVOPO₄, LMFP, AlPO₄, CoPO₄, and LiTi₂(PO₄)₃. Examples of spinel type include LMO and LNMO. Examples of MnNiO₂ type include LiMn_{0.7}Ni_{0.3}O₂.

In some examples, LMFP may include LiMnₓFe₁₋ₓPO₄ (0<x≤1), LiMn_{0.7}Fe_{0.3}PO₄, LiMn_{0.6}Fe_{0.4}PO₄, LiMn_{0.8}Fe_{0.2}PO₄, LiMn_{0.75}Fe_{0.25}PO₄. In some examples, the LMFP particles are doped. Examples of doped LMFP particles include LiMn_{0.7} Mg_{0.05}Fe_{0.25}PO₄ and LiMn_{0.75}Al_{0.05}Fe_{0.2}PO₄.

In some examples, the LMFP particle size is in a range from 10 nm to 1000 nm. In some examples, the LMFP particle size is in a range from 50 nm to 300 nm. In some examples, the LMFP tap density is in a range from 0.3 g/cc to 2.0 g/cc. In some examples, the LMFP tap density is in a range from 0.4 g/cc to 0.9 g/cc. In some examples, the LMFP specific area is in a range from 3 m²/g to 50 m²/g. In some examples, the LMFP specific area is in a range from 15 m²/g to 35 m²/g. In some examples, the coating layer comprises 0.5 wt % to 10% mass ratio. In some examples, the coating layer comprises 1.5 wt % to 3% mass ratio.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A cathode electrode comprising:
a cathode current collector; and
a cathode active material layer comprising a plurality of cathode active material particles including nickel and a plurality of nano-particles that are mechanically inlaid on outer surfaces of the plurality of cathode active material particles to form a plurality of inlaid cathode active material particles.

2. The cathode electrode of claim 1, wherein the plurality of cathode active material particles comprise a rock salt layered oxide including nickel.

3. The cathode electrode of claim 1, wherein the plurality of cathode active material particles are selected from a group consisting of LiNiₓMn_{y}Co_{1-x-y}O₂, LiNₓCo_{y}Al_{1-x-y}O₂, LiNiₓCo_{y}Mn_{z}Al_{1-x-y-z}O₂, LiNiₓMn_{y}Al_{1-x-y}O₂, LiNiₓMn₁₋ₓO₂, and LiNiO₂.

4. The cathode electrode of claim 1, wherein the plurality of nano-particles comprise 1% to 25% of a mass ratio of inlaid cathode active material particles.

5. The cathode electrode of claim 1, wherein the plurality of nano-particles are selected from a group consisting of olivine type, spinel type, MnNiO₂ type, and combinations thereof.

6. The cathode electrode of claim 1, wherein the plurality of nano-particles are selected from a group consisting of LiVOPO₄, LMFP, AlPO₄, CoPO₄, LiTi₂(PO₄)₃, LMO, LNMO, LiMn_{0.7}Ni_{0.3}O₂, and combinations thereof.

7. The cathode electrode of claim 1, wherein the plurality of nano-particles comprise LMFP selected from a group consisting of LiMnₓFe₁₋ₓPO₄, LiMn_{0.7}Fe_{0.3}PO₄, LiMn_{0.6}Fe_{0.4}PO₄, LiMn_{0.8}Fe_{0.2}PO₄, LiMn_{0.75}Fe_{0.25}PO₄, and combinations thereof.

8. The cathode electrode of claim 1, wherein the plurality of nano-particles comprise doped LMFP.

9. The cathode electrode of claim 1, wherein the plurality of nano-particles comprise LMFP and a particle size of the LMFP is in a range from 10 nm to 1000 nm.

10. The cathode electrode of claim 1, wherein the plurality of nano-particles comprise LMFP and a tap density of the LMFP is in a range from 0.3 g/cc to 2.0 g/cc.

11. The cathode electrode of claim 1, wherein the plurality of nano-particles comprise LMFP and a specific area of the LMFP is in a range from 3 m²/g to 50 m²/g.

12. The cathode electrode of claim 1, further comprising a carbon coating layer arranged on an outer surface of the plurality of inlaid cathode active material particles.

13. The cathode electrode of claim 12, wherein the carbon coating layer comprises at least one of carbon and N-doped carbon.

14. The cathode electrode of claim 12, wherein the carbon coating layer comprises 0.5 wt % to 10% mass ratio of the inlaid cathode active material particles.

15. A method for manufacturing a cathode electrode for a battery, comprising:
providing a plurality of cathode active material particles including nickel; and
mechanically inlaying a plurality of nano-particles on an outer surface of the cathode active material particles to form inlaid cathode active material particles.

16. The method of claim 15, further comprising:
creating a mixture including the inlaid cathode active material particles, a conductive additive, and a binder; and
coating a cathode current collector with the mixture.

17. The method of claim 15, further comprising forming a carbon coating layer on the inlaid cathode active material particles.

18. The method of claim 15, wherein:
the cathode active material particles are selected from a group consisting of LiNiₓMn_{y}Co_{1-x-y}O₂, LiNₓCo_{y}Al_{1-x-y}O₂, LiNiₓCo_{y}Mn_{z}Al_{1-x-y-z}O₂, LiNiₓMn_{y}Al_{1-x-y}O₂, LiNiₓMn₁₋ₓO₂, and LiNiO₂; and
the plurality of nano-particles are selected from a group consisting of olivine type, spinel type, MnNiO₂ type, and combinations thereof.

19. The method of claim 15, wherein the plurality of nano-particles are selected from a group consisting of LiVOPO4, LMFP, AlPO4, CoPO4, LiTi2(PO4)3, LMO, LNMO, LiMn0.7Ni0.3O2, and combinations thereof.

20. The method of claim 19, wherein the plurality of nano-particles comprise doped LMFP.
